(19) United States
(12) Patent Application Publication
(10) Pub. No.: US 2026/0264382 A1
(43) Pub. Date: Sep. 10, 2026

(54) WASHABLE LAMINATE AND METHODS OF ADHESIVE ISOLATION

(71) Applicant: Avery Dennison Corporation, Mentor, OH (US)

(72) Inventors: Peter J. HEEDERIK, Hillegom (NL); Danny KRIJGSMAN, Katwijk (NL); Morice L. HOOGTEIJLING, Leiderdorp (NL)

(21) Appl. No.: 19/166,182

(22) PCT Filed: Apr. 25, 2024
(86) PCT No.: PCT/IB2024/054047

§ 371 Date: Sep. 17, 2025

Related U.S. Application Data
(60) Provisional application No. 63/498,283, filed on Apr. 26, 2023.

(51) Int. Cl. B32B 27/32; B32B 7/06; B32B 7/12; B32B 17/10; B32B 27/08; B32B 38/00

(52) U.S. Cl. CPC B32B 27/32; B32B 7/06; B32B 7/12; B32B 17/10; B32B 27/08; B32B 38/0036; B32B 2250/24; B32B 2307/30; B32B 2307/514; B32B 2307/736; B32B 2307/748; B32B 2323/10; B32B 2519/00

(57) ABSTRACT

Exemplary embodiments generally relate to washable laminate constructions that are operative to isolate the adhesive component during wash-off conditions. More specifically, embodiments are directed towards methods relating to isolating adhesives through means of oriented polypropylene and non-oriented overlaminates curling towards the adhesive and constructions thereof.

### TECHNICAL FIELD

This disclosure generally relates to washable laminate constructions that are operative to isolate the adhesive component during wash-off conditions. More specifically, embodiments are directed towards methods relating to isolating adhesives through means of oriented polypropylene and non-oriented overlaminates curling towards the adhesive and constructions thereof.

### BACKGROUND

Adhesive labels are currently applied to a wide variety of articles for many different types of purposes. Examples of such labeled articles include, but are not limited to, commercial vehicles adorned with decals that identify a business name or trademark of the vehicle owner, window storefronts labeled with decals that disclose the name of the business, private vehicles decorated with bumper stickers that display a message wished to be conveyed by the vehicle owner, and containers for beverages, detergents or health and beauty aids decorated with labels that identify the type of product contained therein and/or a trademark for the product. Even wooden tabletops have been decorated by certain restaurant chains with adhesive labels displaying a restaurant logo or the like.

It is common practice to apply labels to containers or bottles formed from polymers or glass. Such containers and bottles are available in a wide variety of shapes and sizes for holding many different types of materials such as detergents, chemicals, motor oil, beverages, including juices, soft drinks, alcoholic beverages, etc. The labels provide information such as the supplier of the container or the contents of the container.

Polymeric film materials and film facestocks have been described for use as labels in various fields. Polymeric labels are increasingly desired for many applications, particularly clear polymeric labels since they provide a no-label look to decorated glass and plastic containers. Paper labels block the visibility of the container and/or the contents in the container. Clear polymeric labels enhance the visual aesthetics of the container, and therefore the product, and are growing much faster than paper labels in the package decoration market as consumer product companies are continuously trying to upgrade the appearance of their products. Polymeric film labels also have superior mechanical properties, such as tensile strength and abrasion resistance.

Further, recyclability of both substrates as well as packaging has become of utmost importance in today's world. Unfortunately, exposure of adhesives within the recycling stream can prove problematic, as it may begin to degrade the removal techniques of labels. Specifically, adhesives may cause issues in further processing steps after removal of the label, which is undesirable for recyclers.

Accordingly, it would be desirable to produce polymeric film labels that can be completely removed from the bottles during the washing process, sequester or isolate the adhesive, yet maintain their superior aesthetic and mechanical properties. Additionally, it would be desirable to produce polymeric film labels that will isolate the adhesive directly after washing off by means of curling towards the adhesive layer. It would also be desirable to produce a polymeric label having a pressure sensitive adhesive that is capable of being coated onto the polymeric film at high speeds and that can be quickly and cleanly removed from the bottle or substrate.

### SUMMARY

Exemplary embodiments relate to a method comprising: exposing a labeled substrate to wash-off temperature and wash-off solution, wherein the labeled substrate comprises a multilayer film and an adhesive layer, wherein the adhesive layer has a coatweight less than 15 gsm, and wherein the multilayer film includes: a first layer comprising polypropylene and a second layer made of oriented film; and wherein the first layer overlaminates at least a portion of the second layer; and curling the multilayer film towards the adhesive layer and substrate as a result of exposing the laminate to the wash-off temperatures and solution. This embodiment or another exemplary embodiment may provide for the curling of the multilayer film isolates the adhesive layer from the wash-off solution. This embodiment or another exemplary embodiment may provide for the second layer of the multilayer film comprises a shrinkable polypropylene. This embodiment or another exemplary embodiment may provide for the second layer of the multilayer film has a shrinkage in the range of about 20% to about 50%. This embodiment or another exemplary embodiment may provide for the second layer of the multilayer film has a shrinkage in the range of about 30% to about 40%. This embodiment or another exemplary embodiment may provide for the multilayer film consists of a monomaterial. This embodiment or another exemplary embodiment may provide for the multilayer film consists of polypropylene. This embodiment or another exemplary embodiment may provide for the adhesive layer comprises at least one of a structural adhesive and a pressure sensitive adhesive. This embodiment or another exemplary embodiment may provide for deactivating the adhesive layer at or above wash-off temperatures. This embodiment or another exemplary embodiment may provide for reactivating the adhesive layer upon drying and below wash-off temperatures. This embodiment or another exemplary embodiment may provide for the curling of the multilayer film is permanent. This embodiment or another exemplary embodiment may provide for the substrate comprises at least one of polyethylene terephthalate and polypropylene. This embodiment or another exemplary embodiment may provide for the substrate comprises glass. This embodiment or another exemplary embodiment may provide for prior to exposing the multilayer film to wash-off temperature and solution the substrate and multilayer film is shredded in one direction.

Additional exemplary embodiments may relate to a composition comprising: a first layer comprising a polypropylene label film; a second layer comprising a shrinkable polypropylene; wherein the first layer, second layer, comprise a laminate construction; an adhesive layer, wherein the adhesive layer has a coatweight less than 15 gsm; and wherein when the laminate construction is operative to curl in a direction towards the adhesive layer when exposed to wash-off temperatures and solution. This embodiment or another exemplary embodiment may provide for the second layer has a shrinkage in the range of about 20% to about 50%. This embodiment or another exemplary embodiment may provide for the second layer has a shrinkage in the range of about 30% to about 40%. This embodiment or another exemplary embodiment may provide for the first layer overlaminates at least a portion of the second layer and the second layer is in contact with the adhesive. This embodiment or another exemplary embodiment may provide for the adhesive comprises at least one of a structural adhesive and a pressure sensitive adhesive. This embodiment or another exemplary embodiment may provide for the first layer and second layer are monomaterials.

### BRIEF DESCRIPTION OF THE DRAWINGS

FIG. 1 refers to an exemplary laminate construction discussed within this disclosure.

FIG. 2 refers to an exemplary laminate construction when exposed to wash-off conditions in accordance with this disclosure.

### DEFINITIONS

As used herein. “wash-off” refers to the property of a label or other laminate structure to be removed during exposure to a solution washing liquids operative to cause separation of the label or other laminate and the substrate to which it is adhered. This is generally done with some form of caustic solution and temperatures above 50° C.

As used herein, “monomaterial” refers to a product composed of a single type of materials or fibers (i.e. polypropylene), as opposed to a product made from different materials. The inclusion of a monomaterial makes the related recycling processes much easier, as it reduces the amount of energy required to properly separate various materials within the recycling stream

As used herein, “gsm” means grams per square meter.

### DETAILED DESCRIPTION

### Adhesives

The laminates/constructs described herein contain one or more adhesives. The adhesive(s) can be a PSA, a non-pressure sensitive adhesive, a hot-melt adhesive, or combinations thereof. In some embodiments, the adhesive is a PSA. The PSA may be any known PSA. In some embodiments, the PSA is a solvent type adhesive, an emulsion type adhesive, or non-emulsion type adhesive. In some embodiments, the PSA is an emulsion adhesive. Hot melt PSAs may also be used. The adhesive may be acrylic or any other useful adhesive which has the hardness and adhesive properties needed for the laminates and/or adhesive coated facestocks. In certain embodiments, the adhesive should have a hardness sufficient to prevent the adhesive squeezing out of the laminate or article during processing.

Exemplary PSAs may be found in (1) Encyclopedia of Polymer Science and Engineering, Vol. 13, Wiley-Interscience Publishers (New York, 1988); (2) Polymer Science and Technology, Vol. 1, Interscience Publishers (New York, 1964); (3) those described in U.S. Pat. Nos. 5,164,444; 5,183,459; and 5,264,532, all issued to Bernard, and U.S. Pat. No. 5,385,965, issued to Bernard et al; and (4) combinations thereof. The PSAs may be a solvent based or may be a water based adhesive. Conventional PSAs, including acrylic-based PSAs, rubber-based PSAs and silicone-based PSAs may be used in the laminates/constructs described herein. In one embodiment, the pressure sensitive adhesive contains an acrylic emulsion adhesive.

In some embodiments, the pressure sensitive adhesive is prepared by polymerizing alkyl acrylates, vinyl esters, diesters of dicarboxylic acids and unsaturated acids. The alkyl acrylates typically contain from about 2 to about 12, or from about 4 to about 8 carbon atoms in the alkyl group. Examples of alkyl acrylates include, but are not limited to, ethyl, n-butyl, hexyl, 2-ethylhexyl, and isooctyl acrylates, with 2-ethylhexyl acrylate preferred. In one embodiment, the alkyl acrylates are present in an amount of at least about 35%. In some embodiments, the alkyl acrylates are present in an amount from about 35% to about 60% by weight.

The vinyl esters typically have from about 2 to about 12, or from about 4 to about 8 carbon atoms in the alkyl group. Examples of vinyl esters include, but are not limited to, vinyl acetate, vinyl propionate, vinyl butyrate, vinyl versatate and the like, with vinyl acetate being preferred. In some embodiments, the vinyl esters are present in an amount from about 15% to about 35% or from about 20% to about 25% by weight.

The diesters of the dicarboxylic acids include alkyl esters of unsaturated diacids, such as maleic acid or anhydride and fumaric acids. The alkyl group generally contains from about 2 to about 20, or from about 4 to about 16, or from about 6 to about 12 carbon atoms. Examples of diesters of diacids include, but are not limited to, butyl, octyl fumarate; hexyl, decyl maleate; di-2-ethylhexyl maleate; di-butyl fumarate; and di-2-ethylhexyl fumarate and mixtures thereof. In some embodiments, the diesters of diacids are present in an amount from about 20% to about 35% by weight.

The unsaturated acids generally contain from about 2 to about 12, or from about 2 to about 6 carbon atoms. Examples of the unsaturated acids include, but are not limited to, acrylic acid, methacrylic acid, itaconic acid, and the like. In some embodiments, the unsaturated acids are present in an amount up to 5% or from about 1% to about 3% by weight.

In exemplary embodiments, the coat weight of adhesives may be between 1 and 100 gsm. In exemplary embodiments, the coat weight is less than 15 gsm. In the same or other embodiments, the coat weight is less than 15 gsm and the adhesive is an emulsion adhesive. In certain embodiments, depending on the facestock used with the desired implementation, hot melt style adhesives applied at coat weights over 30 gsm can cause premature curling of a label stock. Further, if an emulsion adhesive is used at higher coatweights above 25 gsm, it becomes impractical to coat at speed, is slow to dry, exceedingly expensive, and can cause bleeding to the facestock and other layers.

### Release Liners

In some embodiments, the laminates described herein may include one or more release liner(s). The liner may have a first side, a second side opposed to the first side, a first edge, and a second edge opposed to the second edge. The liner may be any useful liner which provides necessary support and release properties. The liner may be made of, or from, a variety of materials including, but not limited to, paper or polymer film liners. In one embodiment, the caliper of the paper is sufficient to die cut the resulting laminate or article. For example, liner calipers can range from about 18 μm to about 30 μm for PET liners. In one embodiment, the liner has lay flat properties. In some embodiments, the liner has a machine glaze or finish. In some embodiments, the liner has a silicone hold out layer. The hold out layer provides adhesion between the release coating and the release liner. The silicone holdout layer also prevents the silicone release coating from soaking into the liner.

In some embodiments, the release liner includes a liner having a release coating. The release coating of the release liner provides a releasable bond with the PSA or other adhesive. The release coating may be any composition which provides a desired releasable bond strength.

In one embodiment, the release coating is a silicone release coating. The release coating can be prepared by curing silicone polymers in the presence of a control release agent. In some embodiments, the control release agent is a copolymer of a monofunctional silicone unit of the formula R₃SiO_{1/2} and tetrafunctional silicone units SiO_{4/2} wherein R is an alkyl or alkenyl group. In one embodiment, the alkyl or alkenyl groups contain from about 1 to about 12, or from about 1 to about 6 carbon atoms. Non-limiting examples of alkyl and alkenyl groups include methyl, ethyl, propyl, butyl, hexyl, ethenyl, propenyl, butenyl and hexenyl groups.

The control release agent is typically reacted with a polysiloxane. The polysiloxane may be any polysiloxane which is useful in forming a release coating. Examples of useful polysiloxanes include, but are not limited to, vinyl terminated, hydroxy terminated and epoxy terminated polysiloxanes. In one embodiment, the polysiloxane is a functional polydialkyl siloxane, wherein the alkyl group contains from about 1 to about 6 carbon atoms. The alkyl groups independently include, but are not limited to, methyl, ethyl, propyl, butyl, pentyl, hexyl groups or mixtures thereof. In one embodiment, the alkyl or alkenyl group contains from 1 to about 12, or from 1 to about 6 carbon atoms. The polysiloxane typically has a viscosity average molecular weight of greater than 300,000 centipoise (cps). In another embodiment, the polysiloxane has a viscosity molecular weight from about 300,000 to about 1,000,000 or more. The polysiloxane may be represented by the formula (I):

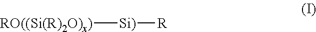

wherein each R is independently as defined above and x is an integer.

In some embodiments, the release coating is prepared with a cross linking agent. In some embodiments, the cross linking agent is a reactive polysiloxane, such as a polydialkyl or polyhydroalkyl siloxane. The alkyl groups are the same as those described above

The release coating may be applied in a solvent, solvent-less or emulsion form. The release coating may be cured by any known curing process, e.g. thermal, radiation, etc., to form the release coating. The curing may be catalyzed by silicone soluble complexed compounds of Group VIII transition metals, such as platinum.

Commercially available release agents include, but are not limited to, GE SS-4335, a silicone release agent in unreactive solvent. Commercially available polysiloxanes include, but are not limited to, GE SS-4331, a vinyl terminated polydimethyl siloxane. Commercially available linking agents include, but are not limited to, GE SS-4300C, a polymethyvinyl siloxane. Exemplary catalysts include, but are not limited to, SS-8010 catalyst in toluene. These materials are available commercially from General Electric Company's Silicone Products Division. Similar silicone products are available under the tradename Syl-off from Dow Corning Corporation.

It will be understood that the present subject matter is not limited to any of the noted release coatings or agents, and instead includes nearly any release coating or agent suitable for the intended end use application. Furthermore, although the present subject matter has been described in association with release liners, it will be appreciated that appropriately configured carrier films and other members could be used instead of release liners, and be so called linerless constructions.

### Face Material

Suitable face materials include, but are not limited to, synthetic papers such as polyolefin type and polystyrene type; various plastic films or sheets such as polyolefin, polyvinyl chloride, polyethylene terephthalate, polystyrene, polyurethane, polymethacrylate and polycarbonate. The face material may be, or may include, a multilayer polymeric sheet. The multi-layers may be coextruded, or the multi-layers may be laminated together. In one embodiment, the face material includes both coextruded multi-layers and laminated multi-layers. In addition, a white opaque film may be formed by adding a white pigment to one or more of the aforementioned synthetic resins and used as the face material. In one embodiment, a foamed film is used as the face material. The foamed film may be formed by a conventional foaming operation. In another embodiment, the face material may be a laminated body formed by combining a plurality of single layered sheets composed of the above listed materials. Examples of such a laminated body may include the combination of cellulose fiber paper with synthetic paper, and a laminated body of combined cellulose fiber paper with a plastic film or sheet. In another suitable embodiment, the face material includes coated and uncoated papers, metalized papers, aluminum foil, laminated paper and paper with a polymeric material extruded onto the surface of the paper. In certain versions, the face material can be coated with a liquid absorbent material. The selected face material may be porous or semi-porous. The face material may exhibit certain visibility characteristics such as opaqueness, color, and/or brightness. The face material may include water or other liquid absorbency properties. The face material may be electrically conductive and/or include electrically conductive coatings or regions. A wide array of commercially available face materials can be used such as for example those available under the designation TESLIN.

The thickness of the face material is optionally determined with reference to application specific criteria. Such criteria may include the desired end use. In one embodiment, the sheet thickness is in a range of from about 10 μm to about 300 μm. In another embodiment, the sheet thickness is in a range of from about 20 μm to about 200 μm. In still another embodiment, the sheet thickness is in a range of from about 30 μm to about 150 μm. Optionally, a primer treatment or a corona discharging treatment or a plasma treatment may be used on the face material to increase a bonding strength between the face material and a dried topcoat composition to be formed on a surface of the face material.

In certain embodiments described herein, the face material exhibits one or more functions or functional characteristics. For example, the face material may be selected to enable or promote an indication such as a visual indication of a liquid, outgassing such as directing or allowing flow of air or gas across a thickness of the face material, water or liquid retention within the face material, electrical discharge or conductivity of the face material, chemical delivery across a thickness of the face material, passage of sound across a thickness of the face material, and/or combinations of these functions or characteristics.

### Overlaminate Layers

The adhesive coated face material and/or laminates described herein can include one or more additional layers or components. Non-limiting examples of such layers include protective layers, tie coat layers, clear layers, color layers, white layers, reflective layers, fluid transfer layers, strength promoting layers, topcoats, print receptive layers, print containing layers, indicia layers, functional layers, and the like.

### Optional Layers

The adhesive coated face material and/or laminates described herein can include one or more additional layers or components. Non-limiting examples of such layers include protective layers, tie coat layers, clear layers, color layers, white layers, reflective layers, fluid transfer layers, strength promoting layers, topcoats, print receptive layers, print containing layers, indicia layers, functional layers, barrier coatings, and the like.

### Laminate Properties

The laminates described herein may have specific and useful properties or functionalities. In some embodiments, the techniques described herein enable formation of laminates in which transfer, propagation, and/or migration of liquid, gas, sound waves, electrical current, and/or other agents or elements can occur and is controlled across or through the laminate in a Z-direction. The reference to “Z-direction” as made herein refers to a direction across a thickness dimension of a laminate or portion thereof, and thus references to “X-direction” and/or “Y-direction” refer to directions perpendicular to the Z-direction and correspond to width and length dimensions of the laminate.

Non-limiting representative examples of laminates having certain functionalities which are provided by the present subject matter include liquid indicator laminates, outgassing laminates, water absorbent laminates, sound channeling laminates, electrically conductive laminates, and laminates having combinations of these functionalities and/or laminates having combinations of one or more of these functionalities and additional functionalities.

For example, a liquid indicator laminate can be produced such that the speed of the indicator color change is linked to the facestock selection and porous adhesive properties. A discontinuous structure, such as resulting from pores in the adhesive layer or region(s), can allow, for example, liquid to channel through the discontinuous adhesive from one side of the adhesive to the other side and create a permanent discoloration when a dye or other agent in a functional coating in the laminate is dissolved.

In one embodiment, a liquid indicator laminate is provided. The speed or rate of the indicator color change is linked to the facestock properties such as for example absorbency of liquid, and porosity of the pattern adhesive in the Z-direction. The indication typically is irreversible and can be measured by color change or by a simple visual comparison.

The discoloration of a face or region of the laminate can be measured and quantified by optical change, such as by CIE Lab or by a simple visual comparison. The discoloration can be permanent or nonpermanent. The discoloration can also be temporary and revert to an initial state after passage of a period of time. In some embodiments, the period of time is predetermined.

This phenomenon of transport through discontinuities in an adhesive in the Z-direction can be implemented in other label applications and particularly pressure sensitive adhesive labels, such as for example, labels for outgassing substrates such as by air channeling in the Z-direction, moist substrate labeling such as by liquid channeling in the Z-direction, electrical discharge in the Z-direction, chemical delivery from one layer to another in the Z-direction, and/or sound channeling in the Z-direction. This phenomenon enables passage, transfer, and/or migration of a medium or agent from one side of an adhesive region of a laminate, to another side of the adhesive region. Although medium penetration or transport is noted as being in the Z-direction, it will be understood that the present subject matter is not limited to such and may also include penetration/transport in the X-direction and/or Y-direction.

In some embodiments, the laminates described herein include a layer or region of a secondary adhesive. The secondary adhesive is typically utilized to adhere the laminate to a substrate of interest. The secondary adhesive may contain one or more adhesives which are the same or different than the adhesive of the patterned or porous adhesive. Description of representative examples of secondary adhesives are provided herein. In such an adhesive configuration, the primary adhesive may be coated onto the facestock, the secondary adhesive may be coated onto the release liner, and the coated adhesive and release liner may be laminated together such that the primary and secondary adhesives are in direct contact with each other. Alternatively, or additionally, both the primary and secondary adhesive may be coated on the facestock or the release liner, then laminated together. It is contemplated that the layering of the primary and secondary adhesive relative to the facestock and the release liner may be either facestock, primary adhesive, secondary adhesive, and release liner or facestock, secondary adhesive, primary adhesive, release liner.

In some embodiments, an array of different arrangements of layers and components may be utilized. In some embodiments using the patterned adhesive, e.g., the layer of discontinuous adhesive, that layer is disposed between a functional facestock and a liner or functional layer. And in the liquid indicator laminates, the patterned adhesive may be disposed between the functional facestock and the layer or region of functional agent that is sensitive to liquid passing through the laminate. And, in the liquid indicator laminates, the layer or region of the functional agent may be disposed between the patterned adhesive and the carrier layer.

Utilization of the techniques and features described herein enable production of adhesive laminates and/or adhesive coated face materials with fluid/air management characteristics, controlled removability, and/or unique thermal and/or electrical conductivity. In addition, use of these techniques and features enable reductions in materials, e.g., adhesives, and thus enable cost savings. However, it will be understood that the present subject matter includes the adhesive coated face materials and laminates described herein which are formed by other methods than the methods described herein.

### Top Coat Formulation and Application

In exemplary embodiments discussed herein, the top coat coating is deposited on the substrate by any suitable method. In embodiments, the suitable method includes any suitable coating technology. Embodiments include depositing the coating on the substrate by any suitable liquid deposition method. Without limitation, examples of suitable methods include bath coating, spray coating, slot coating, spin coating, curtain coating, gravure coating, reverse gravure print coating, reverse roll coating, knife over roll (i.e., gap) coating, metering (Meyer) rod coating, air knife coating, or any combinations thereof. Bath coating includes immersion or dip in the aqueous solution. In an embodiment, the coating is deposited by bath in the aqueous solution. In other embodiments, the coating is deposited by spray of the aqueous solution.

### Exemplary Laminate Constructions

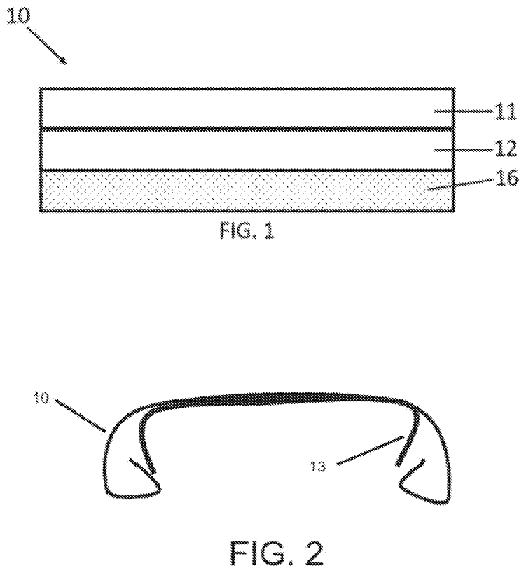

Having described many, non-limiting components of potential laminate construction, attention will now be directed to specific constructions in accordance with the disclosure. Referring specifically to FIG. 1, a simplistic non-limiting example of a construction 10, is shown. This exemplary embodiment 10 is directed towards a label construction comprising a label stock 11, polypropylene facestock 12 and an adhesive layer 16 to wash from container flakes in the washing process. The facestock 12 of the label is a shrinkable polypropylene, in either machine direction (MD) or cross-machine direction (CD), and on this facestock 12 the adhesive layer 16 is applied. In an exemplary embodiment, the shrink characteristic of the facestock 12 is between about 20% to about 50%. In other embodiments, the shrink characteristic of the facestock 12 may be between about 30% to about 40%. Then, either after or before printing some indicia onto the facestock 12, the shrinkable polypropylene is overlaminated at least partially with a standard label film 11 without shrink capabilities. The label film, in the exemplary embodiment, also comprises polypropylene. In the present embodiment, the constructed laminate 10 forms a monomaterial, and may be recycled in the same stream. In this embodiment or another embodiment, the adhesive layer has a coatweight that is less than 15 gsm. In other embodiments, the coat weight may be between 10 and 15 gsm. In this or other embodiments the adhesive layer may comprise an emulsion type adhesive.

This construction is then applied to a package, bottle, or other similarly situated article. In one embodiment, the laminate is applied to a polyethylene terephthalate container. In this embodiment, the container may be shredded prior to being exposed to wash-off conditions. The container can be shredded in at least one of a first direction, a second direction, and a random direction. In other embodiments, the laminate is applied to a glass substrate.

Referring specifically to FIG. 2, a simplistic view of curling of the laminate towards the adhesive layer 11 is shown. During the wash-off process to remove and begin the recycling process at elevated temperatures, the label will show curling due to the shrink of the facestock layer, and not of the top overlaminated layer, which is not shrink or otherwise oriented. Put another way, this curl occurs towards the adhesive layer and not away from the substrate 13 and will trap the adhesive ensuring no to minimal exposure of adhesive to the wash-off solution, as the laminate isolates the adhesive to the wash-off solution. Upon drying, in an exemplary embodiment, the adhesive will be deactivated at or above wash-off temperatures and not be able to stick to anything it comes in contact with. In this, or another embodiment, the adhesive will reactivate below wash-off temperatures once dried and be able to stick again. In some embodiments, the curling of the laminate can be permanent depending on the desired implementation.

### Methods

Having discussed various components of the apparatus, exemplary methods and methodologies of operation will be discussed.

When the laminate construction is no longer desired to be applied to the article, it may be washed off. This occurs through exposing a laminate attached via an adhesive coated at a coat weight below 15 gsm to a substrate to wash-off temperatures and a wash-off solution. The laminate attached comprises a first layer comprising polypropylene, and a second layer made of oriented polypropylene. The first layer overlaminates at least a portion of the second layer. Then, as a result of being exposed to the wash-off temperatures and the wash-off solution, the laminate will curl towards the adhesive layer. The adhesive layer is thereby isolated from the wash-off solution.

### EXAMPLES

### Example 1

A 19% shrink MD film with an overlaminate of a non-shrink PP was created. The shrink MD film includes a clear treated surface layer, a transparent PP core, and a clear layer below that core. The resultant construction was then coated with a known washoff adhesive at 13 gsm, and subsequently adhered to a PET substrate to give a resultant construction. The resultant construction was then shredded into flakes of uniform size, and then tested in a 1% caustic wash at 80° C. and 13 minutes time with agitation. In that time, none of the flakes curled upon themselves.

### Example 2

A 38% shrink CD film with an overlaminate of a non-shrink PP was created. The shrink MD film includes a corona treated solvent seamable polyolefin layer, a shrinkable polyolefin core, and a second solvent seamable polyolefin layer. The resultant construction was then coated with a known washoff adhesive at 13 gsm, and subsequently adhered to a PET substrate to give a resultant construction. The resultant construction was then shredded into flakes of uniform size, and then tested in a 1% caustic wash at 80° C. and 13 minutes time with agitation. In that time, approximately 80% of the flakes curled toward itself and isolated any adhesive. In this discussion, the polyolefin layer can be any orientable polyolefin or combinations thereof.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0. % of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clarity, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

We claim:

1. A method comprising:
exposing a labeled substrate to wash-off temperature and wash-off solution, wherein the labeled substrate comprises a multilayer film and an adhesive layer, wherein the adhesive layer has a coatweight less than 15 gsm, and wherein the multilayer film includes:
a first layer comprising polypropylene and a second layer made of oriented film; and
wherein the first layer overlaminates at least a portion of the second layer; and
curling the multilayer film towards the adhesive layer and substrate as a result of exposing the laminate to the wash-off temperatures and solution.

2. The method of claim 1, wherein the curling of the multilayer film isolates the adhesive layer from the wash-off solution.

3. The method of claim 1, wherein the second layer of the multilayer film comprises a shrinkable polypropylene.

4. The method of claim 3, wherein the second layer of the multilayer film has a shrinkage in the range of about 20% to about 50%.

5. The method of claim 3, wherein the second layer of the multilayer film has a shrinkage in the range of about 30% to about 40%.

6. The method of claim 1, wherein the multilayer film consists of a monomaterial.

7. The method of claim 6, wherein the multilayer film consists of polypropylene.

8. The method of claim 1, wherein the adhesive layer comprises at least one of a structural adhesive and a pressure sensitive adhesive.

9. The method of claim 1, further comprising:
deactivating the adhesive layer at or above wash-off temperatures.

10. The method of claim 9, further comprising:
reactivating the adhesive layer upon drying and below wash-off temperatures.

11. The method of claim 1, wherein the curling of the multilayer film is permanent.

12. The method of claim 1, wherein the substrate comprises at least one of polyethylene terephthalate and polypropylene.

13. The method of claim 1, wherein the substrate comprises glass.

14. The method of claim 1, wherein prior to exposing the multilayer film to wash-off temperature and solution the substrate and multilayer film is shredded in one direction.

15. A composition comprising:
a first layer comprising a polypropylene label film;
a second layer comprising a shrinkable polypropylene; wherein the first layer, second layer, comprise a laminate construction;
an adhesive layer, wherein the adhesive layer has a coatweight less than 15 gsm; and
wherein when the laminate construction is operative to curl in a direction towards the adhesive layer when exposed to wash-off temperatures and solution.

16. The composition of claim 15, wherein the second layer has a shrinkage in the range of about 20% to about 50%.

17. The composition of claim 15, wherein the second layer has a shrinkage in the range of about 30% to about 40%.

18. The composition of claim 15, wherein the first layer overlaminates at least a portion of the second layer and the second layer is in contact with the adhesive.

19. The composition of claim 15, wherein the adhesive comprises at least one of a structural adhesive and a pressure sensitive adhesive.

20. The composition of claim 15, wherein the first layer and second layer are monomaterials.
